(19) United States
(12) Patent Application Publication
(10) Pub. No.: US 2009/0130921 A1
(43) Pub. Date: May 21, 2009

(54) EXTERNAL SERIAL ATA CONNECTOR

(75) Inventor: Bruce Chiou, Taipei City (TW)

Correspondence Address: SANTA ELECTRONICS INC., P.O.BOX 108-00403, Taipei, 106, omitted

(73) Assignee: SANTA ELECTRONICS INC., Taipei City (TW)

(21) Appl. No.: 12/123,454

(22) Filed: May 19, 2008

(30) Foreign Application Priority Data
Nov. 16, 2007 (TW) 096219479

(51) Int. Cl. H01R 9/22

(52) U.S. Cl. 439/722

(57) ABSTRACT

An eSATA (External Serial Advanced Technology Attachment) connector includes an electrically insulative housing that defines therein a receiving chamber for the insertion of an external interface connector, and a terminal block that has a cantilever type tongue plate suspended in the receiving chamber and a set of eSATA terminals arranged on a first surface of the cantilever type tongue plate for transmission of data signals with the external interface connector that is inserted into the receiving chamber and a set of power terminals arranged on the opposite surface of the cantilever type tongue plate for providing power supply to the external interface connector that is inserted into the receiving chamber.

This application claims the priority benefit of Taiwan patent application 096219479 filed on Nov. 16, 2007.

### BACKGROUND OF THE INVENTION

1. Field of the Invention

The present invention relates to an electrical connector and more particularly, to an eSATA connector, which has a set of eSATA terminals and a set of power terminals arranged on two opposite sides of the cantilever type tongue plate of the terminal block thereof so that the inserted external interface connector obtains the necessary working voltage from the set of power terminals when transmitting data signals through the set of eSATA terminals.

2. Description of the Related Art

A memory stick, mobile hard disk, mobile disc player or peripheral apparatus may be connected to a computer through an external transmission interface, such as USB, IEEE 1394 or the like. USB2.0 is one of the most popularly used transmission interface for computer peripheral apparatus. An USB2.0 connector supports a transmission rate of up to 480 Mbps (Megabits per second) to give better performance.

There is known a relatively faster transmission specification, i.e., SATA (Serial Advanced Technology Attachment) standard. SATA offers performance as high as 3.0 Gbit/sec. SATA uses 4 signal lines, allowing for much more compact. The SATA standard defines a data cable with seven conductors and 8 mm wide wafer connectors on each end. The SATA standard also specifies a new power connector. Like the data cable, it is wafer-based, but its wider 15-pin shape prevents accidental misidentification and forced insertion of the wrong connector type. However, because of the arrangement of signal terminals and power terminals, a SATA connector occupies much the circuit board space and does not accommodate the requirements of light weight, thin, short and small size for electronic products.

There is a special connector (eSATA) specified for external devices, and an optionally implemented provision for clips on internal connectors. eSATA defines separate cables, connectors and revises electrical requirements for external applications. An eSATA connector has light, thin, short and small characteristics, however it does not provide the connected external electronic device with the necessary working voltage.

There are also known improved eSATA connectors with power supply mode. FIGS. 7˜11 show various similar commercial designs.

According to the design shown in FIG. 7, the eSATA connector comprises an electrically insulative housing A1, a metal shield cover A surrounds the electrically insulative housing A1, an eSATA terminal set A2 mounted in the electrically insulative housing A1, and a power terminal set A3 mounted in the electrically insulative housing A1 at one lateral side relative to the eSATA terminal set A2. By means of the eSATA terminal set A2 and the power terminal set A3, the eSATA connector transmits data signals and provides the necessary working voltage to a connected external electronic device.

According to the design shown in FIG. 8, the eSATA connector comprises an electrically insulative housing B1, a metal shield cover B surrounds the electrically insulative housing B1, an eSATA terminal set B2 mounted in the electrically insulative housing B1, and a power terminal set B3 mounted in the electrically insulative housing B1 at one lateral side relative to the eSATA terminal set B2. By means of the eSATA terminal set B2 and the power terminal set B3, the eSATA connector transmits data signals and provides the necessary working voltage to a connected external electronic device.

According to the design shown in FIG. 9, the eSATA connector comprises an electrically insulative housing C1, a metal shield cover C surrounds the electrically insulative housing C1, an eSATA terminal set C2 mounted in the electrically insulative housing C1, and a power terminal set C3 mounted in the electrically insulative housing C1 above the eSATA terminal set C2. By means of the eSATA terminal set C2 and the power terminal set C3, the eSATA connector transmits data signals and provides the necessary working voltage to a connected external electronic device.

According to the design shown in FIG. 10, the eSATA connector comprises an electrically insulative housing D1, a metal shield cover D surrounds the electrically insulative housing D1, an eSATA terminal set D2 mounted in the electrically insulative housing D1, and a USB power terminal set D3 mounted in the electrically insulative housing D1 above the eSATA terminal set D2. By means of the eSATA terminal set D2 and the USB power terminal set D3, the eSATA connector transmits data signals and provides the necessary working voltage to a connected external electronic device.

According to the design shown in FIG. 11, the eSATA connector comprises an electrically insulative housing E1, a metal shield cover E surrounds the electrically insulative housing E1, an eSATA terminal set E2 mounted in the electrically insulative housing E1, and a USB power terminal set E3 mounted in the electrically insulative housing E1 above the eSATA terminal set E2. By means of the eSATA terminal set E2 and the USB power terminal set E3, the eSATA connector transmits data signals and provides the necessary working voltage to a connected external electronic device.

In the aforesaid various improved eSATA connectors with power supply mode, the eSATA terminal set and the power terminal set are separately provided inside the electrically insulative housing for the connection of two separate external interface connectors respectively. These eSATA connectors do not have a low profile characteristic, still requiring much the installation space.

### SUMMARY OF THE INVENTION

The present invention has been accomplished under the circumstances in view. It is the main object of the present invention to provide an eSATA connector, which provides power supply to an external interface connector that is inserted therein, saving much the circuit board space for power connector.

To achieve this and other objects of the present invention, the eSATA connector comprises an electrically insulative housing and a terminal block. The electrically insulative housing defines therein a receiving chamber for the insertion of an external interface connector. The terminal block is fixedly mounted in the electrically insulative housing and has a cantilever type tongue plate suspended in the receiving chamber, having and a set of eSATA terminals are arranged a first surface thereof for transmission of data signals with the external interface connector that is inserted into the receiving chamber and a set of power terminals are arranged on a second surface of the cantilever type tongue plate opposite to the first surface of the cantilever type tongue plate. The power terminals are adopted side for providing power supply to the external interface connector that is inserted into the receiving chamber. Further, the set of power terminals can be a 6 pin, 10 pin or 15 pin design.

### BRIEF DESCRIPTION OF THE DRAWINGS

FIG. 1 is an oblique elevation of an eSATA connector in accordance with a first embodiment of the present invention.

FIG. 2 is a front plain view of the eSATA connector in accordance with the first embodiment of the present invention.

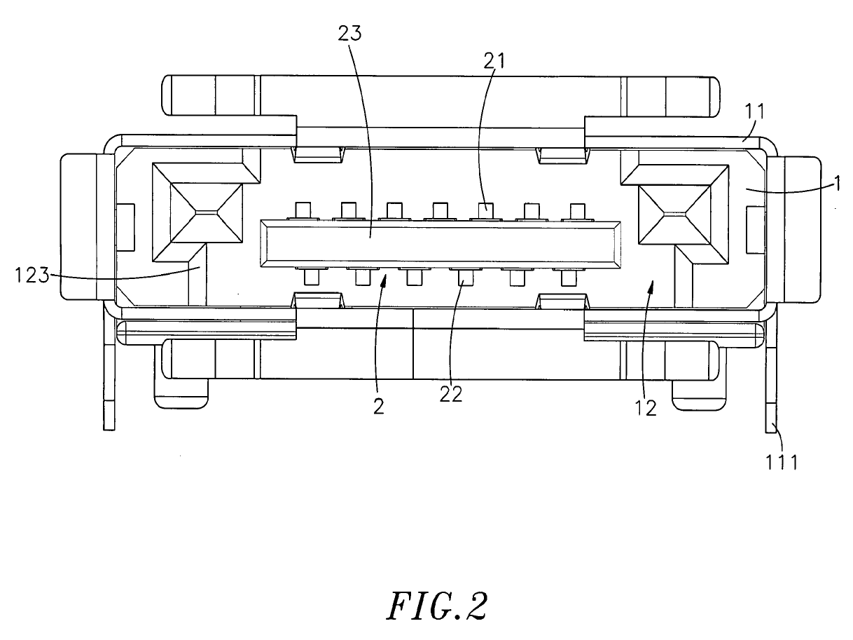

FIG. 3 is a sectional side view of a part of the eSATA connector in accordance with the first embodiment of the present invention.

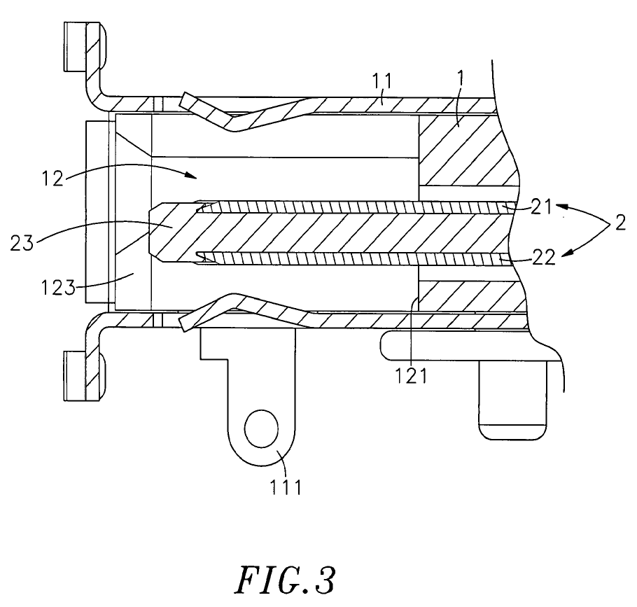

FIG. 4 is a top view in section of the eSATA connector in accordance with the first embodiment of the present invention.

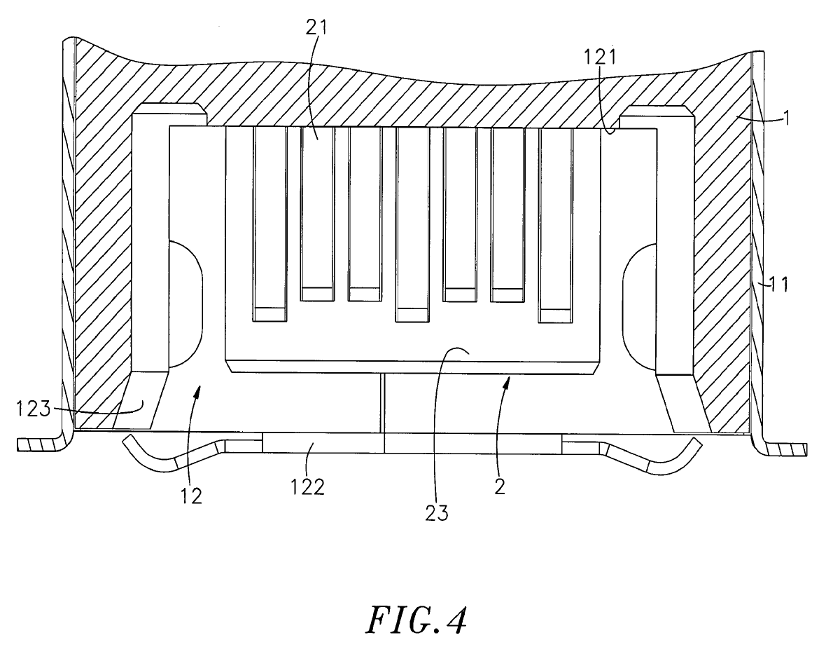

FIG. 5 is a front plain view of an eSATA connector in accordance with a second embodiment of the present invention.

FIG. 6 is a front plain view of an eSATA connector in accordance with a third embodiment of the present invention.

FIG. 7 is an oblique elevation of an eSATA connector according to the prior art.

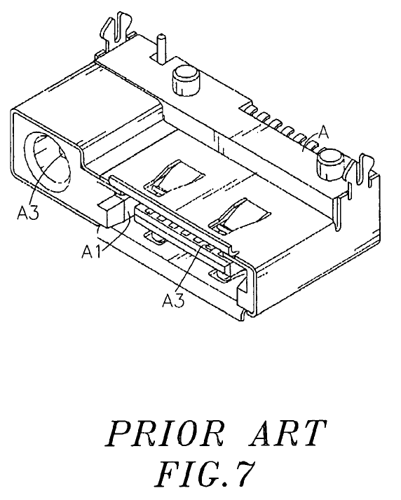

FIG. 8 is an oblique elevation of another structure of eSATA connector according to the prior art.

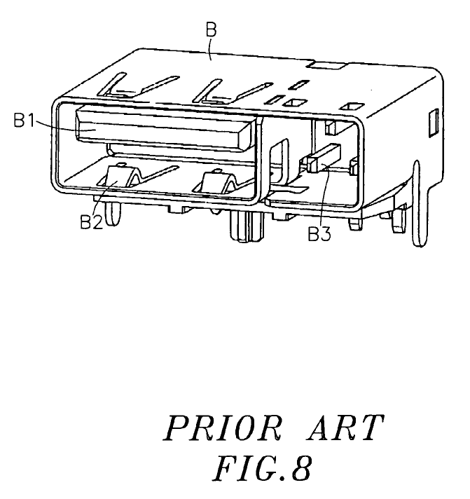

FIG. 9 is an oblique elevation of still another structure of eSATA connector according to the prior art.

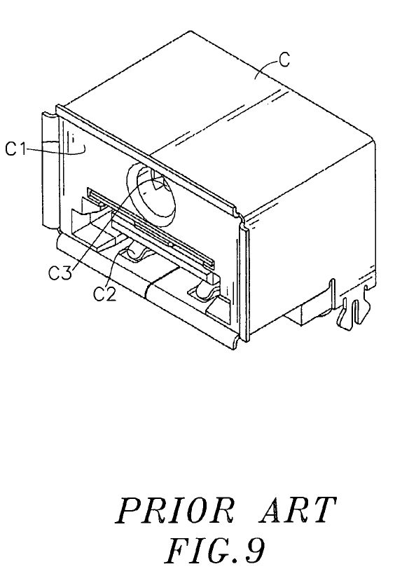

FIG. 10 is an oblique elevation of still another structure of eSATA connector according to the prior art.

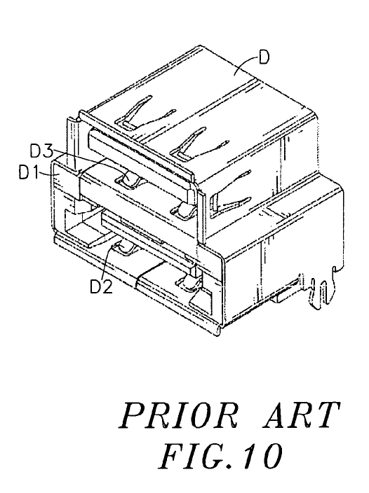

FIG. 11 is an oblique elevation of still another structure of eSATA connector according to the prior art.

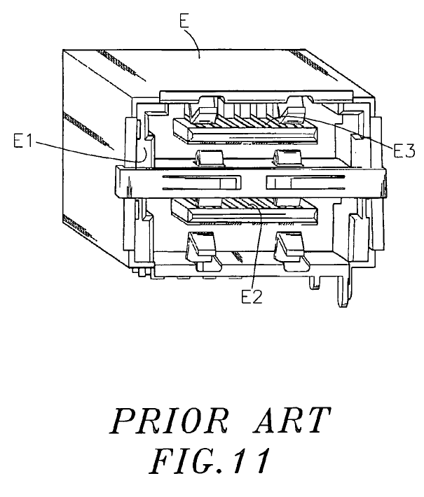

### DETAILED DESCRIPTION OF THE PREFERRED EMBODIMENT

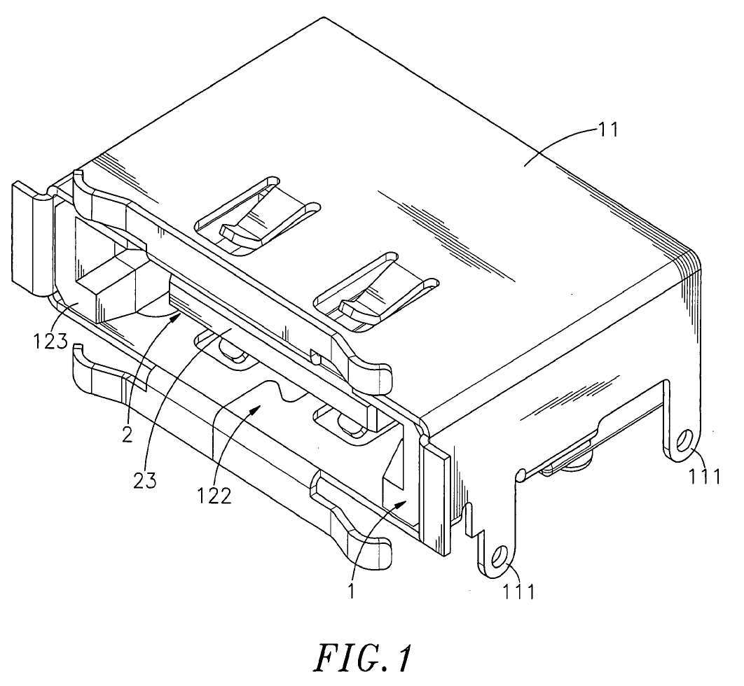

Referring to FIGS. 1˜4, an eSATA (External Serial Advanced Technology Attachment) connector in accordance with the present invention is shown comprising an electrically insulative housing 1 and a terminal block 2.

The electrically insulative housing 1 is externally covered with a metal-shielding cover shell 11. The metal-shielding cover shell 11 has a plurality of downwardly extending bottom mounting portions 111 for bonding to a circuit board (not shown) by soldering. The electrically insulative housing 1 defines therein a receiving chamber 12. The receiving chamber 12 has a back wall 121, a front insertion hole 122 disposed opposite to the back wall 121 and kept in communication with the outside space for the insertion of an external interface connector, and a stepped foolproof structure 123 disposed at two opposite lateral sides of the front insertion hole 122 for preventing incorrect insertion of an external interface connector.

The terminal block 2 comprises a cantilever type tongue plate 23, a set of eSATA terminals 21 are arranged on a first surface of the cantilever type tongue plate 23, and a set of power terminals 22 are arranged on a second surface of the cantilever type tongue plate 23 opposite to the first surface. The set of power terminals 22 provides power supply to the external interface connector (not shown) that is inserted into the receiving chamber 12.

During installation, the cantilever type tongue plate 23 of the terminal block 2 is fixedly mounted inside the receiving chamber 12 in the electrically insulative housing 1. After installation, the cantilever type tongue plate 23 extends from the back wall 121 toward the front insertion hole 122, the set of eSATA terminals 21 are arranged on the first surface of the cantilever type tongue plate 23 and the set of power terminals 22 are arranged on the second surface on the cantilever type tongue plate 23 opposite to the first surface. The set of power terminals 22 can be a 6-pin design, providing 3.3V, 5V, and/or 12V. When an external interface connector is inserted through the front insertion hole 122 into the receiving chamber 12, the external interface connector is electrically connected to the set of eSATA terminals 21 and the set of power terminals 22. At this time, the set of power terminals 22 provides the necessary working voltage to the external interface connector, and the set of eSATA terminals 21 is adapted for transmission of data signals.

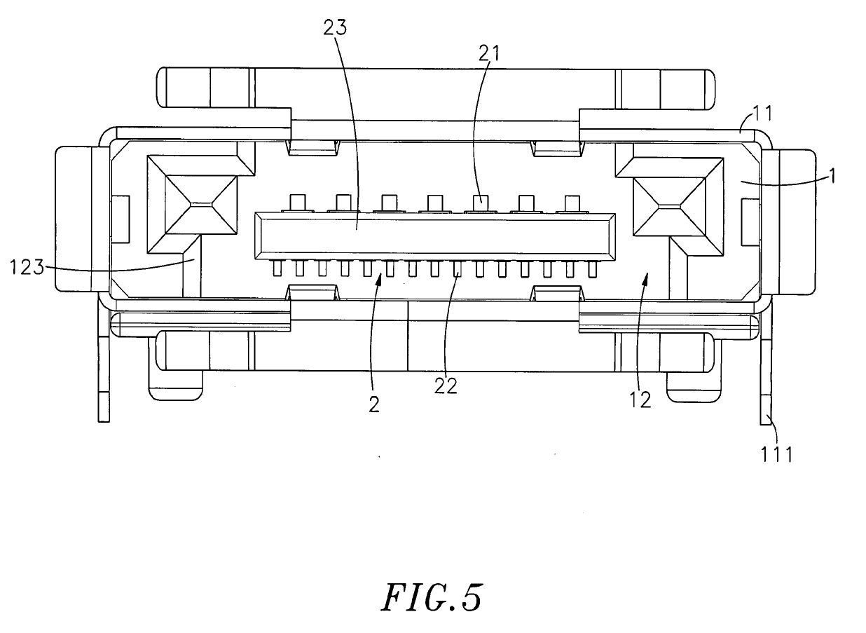

FIG. 5 is a front plain view of an ESATA connector in accordance with a second embodiment of the present invention. This second embodiment is substantially similar to the aforesaid first embodiment with the exception that the set of power terminals 22 according to this second embodiment is a 15 pin design. This second embodiment achieves the same effects as the aforesaid first embodiment, i.e., when an external interface connector is inserted into the receiving chamber 12 and electrically connected to the set of eSATA terminals 21 and the set of power terminals 22 at the two opposite surfaces of the cantilever type tongue plate 23, the set of power terminals 22 provides the external interface connector with the necessary working voltage, and the set of eSATA terminals 21 is adapted for transmission of data signals. Because the set of eSATA terminals 21 and the set of power terminals 22 are arranged at the two opposite sides of the cantilever type tongue plate 23 inside the receiving chamber 12, the eSATA connector requires less circuit board installation space.

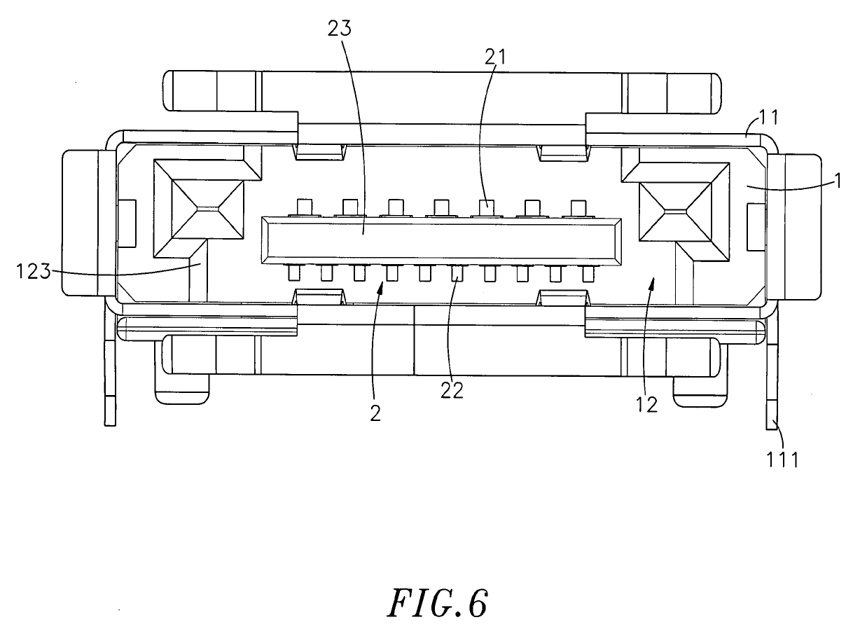

FIG. 6 is a front plain view of an ESATA connector in accordance with a third embodiment of the present invention. This second embodiment is substantially similar to the aforesaid first embodiment with the exception that the set of power terminals 22 according to this third embodiment is a 10 pin design. This third embodiment achieves the same effects as the aforesaid first embodiment, i.e., when an external interface connector is inserted into the receiving chamber 12 and electrically connected to the set of eSATA terminals 21 and the set of power terminals 22 at the two opposite surfaces of the cantilever type tongue plate 23, the set of power terminals 22 provides the external interface connector with the necessary working voltage, and the set of eSATA terminals 21 is adapted for transmission of data signals.

As stated above, the invention provides an eSATA connector that has the following features and advantages:

1. The terminal block 2 of the eSATA connector has the set of eSATA terminals 21 and the set of power terminals 22 arranged the two opposite surfaces of the cantilever tongue plate 23. When upon insertion of an interface connector of an external electronic device, the set of power terminals 22 provides the external electronic device with the necessary working voltage, and the set of eSATA terminals 21 is electrically connected with the external electronic device for transmission of data signals. Therefore, the use of the eSATA connector saves much the circuit board space.

2. By means of the set of power terminals 22, the eSATA connector directly provides the necessary working voltage to the connected external interface connector.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An eSATA (External Serial Advanced Technology Attachment) connector, comprising an electrically insulative housing, said electrically insulative housing defining therein a receiving chamber for the insertion of an external interface connector, and a terminal block fixedly mounted inside said electrically insulative housing, said terminal block comprising a set of eSATA (External Serial Advanced Technology Attachment) terminals arranged on one side thereof for transmission of data signals with the external interface connector that is inserted into said receiving chamber, wherein said terminal block comprises a cantilever tape tongue plate suspended in said receiving chamber and said set of eSATA terminals are arranged on a first surface thereof, and a set of power terminals are arranged on a second surface thereof opposite to said first surface for providing power supply to the external interface connector that is inserted into said receiving chamber.

2. The eSATA connector as claimed in claim 1, wherein said receiving chamber comprises a back wall and a front insertion hole opposite to said back wall; said cantilever type tongue plate of said terminal block extends perpendicularly from said back wall toward said front insertion hole.

3. (canceled)

4. The eSATA connector as claimed in claim 1, wherein said set of power terminals is used for output of at least one of the power ranges of 3.3V, 5V and 12V.

5. The eSATA connector as claimed in claim 1, wherein said set of power terminals is a 6 pin design.

6. The eSATA connector as claimed in claim 1, wherein said set of power terminals is a 10 pin design.

7. The eSATA connector as claimed in claim 1, wherein said set of power terminals is a 15 pin design.

8. An eSATA (External Serial Advanced Technology Attachment) connector, comprising an electrically insulative housing, said electrically insulative housing defining therein a receiving chamber for the insertion of an external interface connector, and a terminal block fixedly mounted inside said electrically insulative housing, said terminal block comprising a set of eSATA (External Serial Advanced Technology Attachment) terminals arranged on one side thereof for transmission of data signals with the external interface connector that is inserted into said receiving chamber, wherein said terminal block comprises a cantilever type tongue plate suspended in said receiving chamber and said set of eSATA terminals are arranged on a first surface thereof, and a set of power terminals arranged on a second surface thereof opposite to said first surface for providing power supply to the external interface connector that is inserted into said receiving chamber; said electrically insulative housing comprises a front insertion hole disposed in communication between said receiving chamber and a space outside the eSATA connector for insertion of an external interface connector, and a foolproof structure adapted to avoid incorrect insertion of an external interface connector.

9. The eSATA connector as claimed in claim 8, wherein said foolproof structure is a stepped structure arranged at two opposite lateral sides of said front insertion hole.

10. The eSATA connector as claimed in claim 8, wherein said set of power terminals is used for output of at least one of the power ranges of 3.3V, 5V and 12V.

11. The eSATA connector as claimed in claim 8, wherein said set of power terminals is a 6 pin design.

12. The eSATA connector as claimed in claim 8, wherein said set of power terminals is a 10 pin design.

13. The eSATA connector as claimed in claim 8, wherein said set of power terminals is a 15 pin design.
